(19) United States
(12) Patent Application Publication
(10) Pub. No.: US 2024/0282536 A1
(43) Pub. Date: Aug. 22, 2024

(54) Keyboard Gasket Mount System

(71) Applicant: Glorious LLC, Austin, TX (US)

(72) Inventor: Ryan Stinebaugh, Homestead, PA (US)

(73) Assignee: Glorious LLC, Austin, TX (US)

(21) Appl. No.: 18/441,749

(22) Filed: Feb. 14, 2024

Related U.S. Application Data
(60) Provisional application No. 63/485,978, filed on Feb. 20, 2023.

(51) Int. Cl. H01H 13/04; H01H 13/70

(52) U.S. Cl. CPC H01H 13/04; H01H 13/70

(57) ABSTRACT

Embodiments of the invention include a keyboard gasket mounting system and a method for using it, the system comprising a keyboard case, wherein the keyboard case comprises a plurality of connection points disposed on a perimeter of the keyboard case; a plurality of gasket modules, wherein each of the plurality of gasket modules comprises at least a top portion and a bottom portion and is configured to removably connect to one or more of the connection points; and a switch plate, wherein the switch plate is configured to rest on the plurality of gasket modules. In embodiments, the keyboard gasket mounting system permits users to easily customize the compressible layer upon which a keyboard's switch plate is mounted in accordance with their respective preferences.

### CROSS-REFERENCE TO RELATED APPLICATION(S)

This application claims the benefit of priority under 35 U.S.C. §§ 120 and 119(e) of U.S. provisional application No. 63/485,978, filed Feb. 20, 2023, entitled “Keyboard Gasket Mount System,” the entire contents of which is incorporated herein by reference.

### TECHNICAL FIELD

The present disclosure generally relates to computer accessories, and more particularly to a gasket mounting system for computer keyboards.

### BACKGROUND

For both enthusiasts and workers, keyboards are one of the most important features of a computer setup. Many users identify their ideal keyboard based on the layout, feel of the keys, sound of the keys, and responsiveness when typing. Mechanical keyboards in particular offer nearly endless customization to help users find their ideal setup. One aspect of a mechanical keyboard that can impact its feel, sound, and responsiveness is the system for mounting the switch plate to the case. Some current solutions use small foam pieces with adhesive as a compressible layer between the switch plate and the keyboard case. This compressible layer allows the switch plate to move vertically as a user types on the keyboard, providing a certain responsiveness that many users desire. The foam, however, can become compressed and lose its springiness over time, and the adhesive can lose its effectiveness, thereby negatively impacting the feel and performance of the keyboard. Other mounting systems use O-ring, silicone, or polymer lattice solutions as a compressible layer, but these solutions may also suffer from a variety of problems, including wearing out over time, being complex to install and/or messy to replace, and having limited customizability. There is therefore a need for a modular system that permits users to easily customize the compressible layer upon which a keyboard's switch plate is mounted.

The present disclosure is directed to overcoming one or more of these above-referenced challenges.

### SUMMARY OF THE DISCLOSURE

Certain aspects of the disclosure disclose a keyboard gasket mounting system and a method for using it, the system comprising a keyboard case, wherein the keyboard case comprises a plurality of connection points disposed on a perimeter of the keyboard case; a plurality of gasket modules, wherein each of the plurality of gasket modules comprises at least a top portion and a bottom portion and is configured to removably connect to one or more of the connection points; and a switch plate, wherein the switch plate is configured to rest on the plurality of gasket modules. In embodiments, each of the plurality of connection points can comprise at least one opening, wherein the bottom portion of each of the plurality of gasket modules comprises at least one protrusion. In alternative embodiments, each of the plurality of connection points can comprise at least one protrusion, wherein the bottom portion of each of the plurality of gasket modules comprises at least one opening. The top portion of each of the plurality of gasket modules can be constructed from foam and the bottom portion can be constructed from one of rubber or plastic. The system can further a plurality of switch plate locators, wherein each of the plurality of switch plate locators can be configured to removably connect to one or more of the connection points, and wherein the switch plate can comprise a plurality of anchor locations, and each of the plurality of anchor locations can be configured to fit around one of the plurality of switch plate locators. In embodiments, the number of connection points can be greater than the number of gasket modules that can be used at any one time, and each gasket module can be connected, disconnected, and reused a plurality of times. An amount of vertical travel of the switch plate can increase when one or more of the plurality of gasket modules are removed from the modular mounting system, and the amount of vertical travel of the switch plate can decrease when one or more of the plurality of gasket modules are added to the system. In some embodiments, the plurality of connection points can comprise a magnetic or ferrous material, and wherein the bottom portion of each of the plurality of gasket modules can comprise a magnetic or ferrous material.

Additional objects and advantages of the disclosed technology will be set forth in part in the description that follows, and in part will be apparent from the description, or may be learned by practice of the disclosed technology.

It is to be understood that both the foregoing summary description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts an embodiment of a keyboard comprising a modular gasket mounting system according to the present disclosure.

FIG. 2 depicts an embodiment of a portion of a keyboard case and a switch plate that is mounted according to the present disclosure.

FIGS. 3A-3B depict embodiments of a gasket module according to the present disclosure.

FIGS. 4A-4B depict embodiments of a portion of a keyboard case that can be used according to the present disclosure.

FIG. 5 depicts embodiments of a portion of a keyboard case and a plurality of modules that are connected to the keyboard case according to the present disclosure.

FIG. 6 depicts embodiments of a switch plate according to the present disclosure.

FIG. 7 depicts a flow chart of an exemplary method according to the present disclosure.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

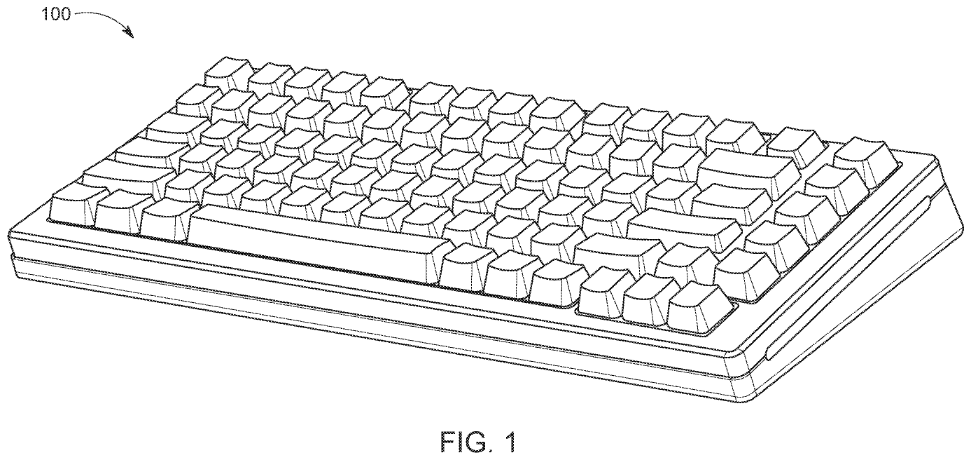

The present disclosure describes a modular gasket mounting system that can be used with computer keyboards, and other computer accessories. FIG. 1 depicts a keyboard 100 that can comprise a modular gasket mounting system in accordance with embodiments of the present invention. Keyboard 100 can comprise one or more components that a user can customize. It is common, for example, for users of keyboards (especially mechanical keyboards) to customize (i.e., by means of replacing existing components with alternative components) keycaps and key switches in accordance with their particular preferences regarding a keyboard's performance, feel, sound, etc. Many users also desire to customize the way the keyboard's switch plate is mounted to the keyboard case. These users may, for example, desire to increase or decrease the amount of vertical travel and/or flex in the switch plate as they type.

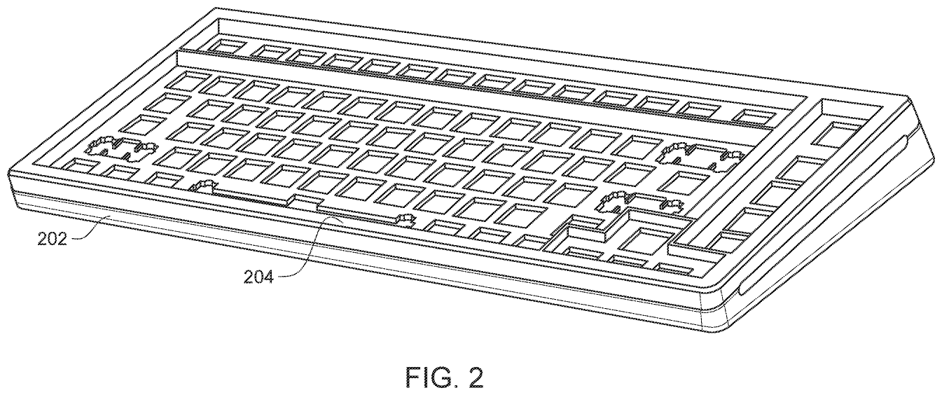

FIG. 2 depicts a portion of a computer keyboard case 202 and a corresponding switch plate 204 that is mounted to the keyboard case 202. The portion of the keyboard case 202 can be a base or bottom portion of a keyboard and can be combined with, among other things, a top portion of a keyboard case. The bottom portion of the keyboard case 202 can house various internal components of the keyboard. The keyboard case 202 can be made of any suitable metal, plastic, or combination thereof.

The switch plate 204 can be mounted to the keyboard case 202. Each of the plurality of openings in the switch plate 204 can be configured to hold a key switch, with each key switch having a corresponding keycap (the keycap and its corresponding switch are collectively referred to herein simply as a “key”). As a user types on a keyboard by pressing on a key, the downward pressure on the key can cause a perceptible amount of vertical travel and/or flex of the switch plate 204. As the user releases the key, the switch plate 204 can return to its original position. The amount of vertical travel and/or flex of the switch plate 204, as well as the speed at which the switch plate 204 returns to its original position (i.e., its “springiness”) can be customized by a user to satisfy their particular preferences. In embodiments of the invention, this customization can be accomplished by adding, removing, and/or repositioning one or more gasket modules. Each gasket module supports a portion of the underside of the switch plate 204 and can be added and removed by hand, without any tools or adhesives.

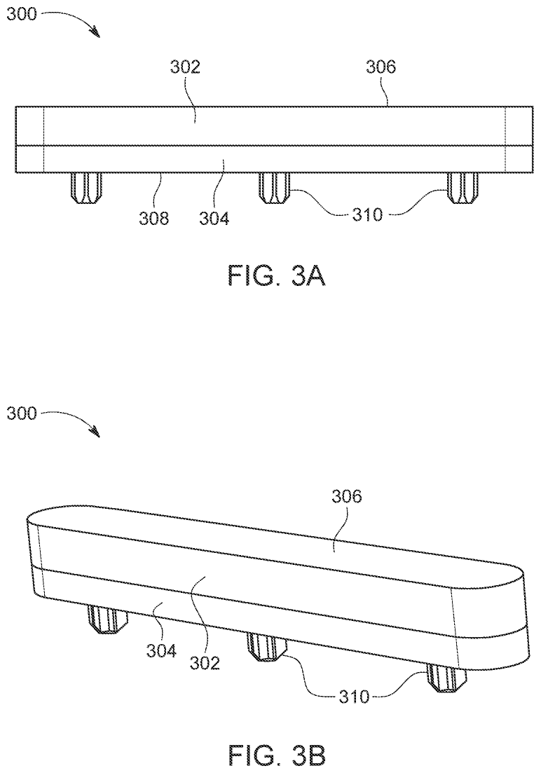

FIGS. 3A-3B depict embodiments of a gasket module 300 that can be used to support the underside of a switch plate (e.g., switch plate 204). Gasket module 300 can be made of one or more materials such as silicone, rubber, foam, plastic, metal, nylon, and/or combinations thereof. Gasket module 300 can comprise one or more portions. In embodiments, gasket module 300 comprises a top portion 302 and a bottom portion 304. In such embodiments, the top portion 302 can be made of a more compressible material such as foam (e.g., a polyurethan foam), silicone, rubber, or combinations thereof. When a user presses a key on the keyboard, thereby applying pressure to the switch plate, the top portion 302 can be compressed or deformed. When the user releases the key, pressure is removed from the switch plate, and the top portion 302 can return to its original shape. The bottom portion 304 of gasket module 300 can be made of a more rigid material such as metal, plastic, foam, silicone, rubber, or combinations thereof, that is less likely to be deformed under pressure from the switch plate as a user presses a key on the keyboard. The top portion 302 can, for example, be adhered to the bottom portion 304 via an adhesive or friction (e.g., a press fit in which some of the top portion or the bottom portion fits inside the other portion). In some embodiments, the top portion and bottom portion can be separated by a user so that the user can replace either or both portions with a respective other top portion or bottom portion. The gasket module 300 can optionally have one or more additional portions layered between the top portion 302 and the bottom portion 304, each being secured to portions above and below it via an adhesive, and being made of one or more of the materials mentioned above. In some embodiments, the top portion 302 and the bottom portion 304 can be made of the same material (e.g., rubber or silicone).

In embodiments, a top surface 306 of the top portion 302 of the gasket module 300 can be uniformly smooth and flat to support the underside of a switch plate. A bottom surface 308 of the bottom portion 304 can have one or more gasket connectors 310 for connecting the gasket module 300 to the keyboard case (e.g., keyboard case 202). Gasket connectors 310 can be one or more of male connectors, female connectors, magnetic connectors, hook and loop connectors, or any other connector that can removably connect the gasket module 300 to a corresponding surface on a keyboard case. In embodiments, each of the one or more gasket connectors 310 can be a protrusion extending downward from the bottom of the gasket module 300 as illustrated in FIGS. 3A-3B.

In some embodiments, a switch plate can rest on the top surface 306 of the top portion 302 of the gasket module without being secured to the gasket module. In alternative embodiments, a top surface of the top portion of the gasket module 300 can have one or more tabs, ridges, grooves, openings, indentations, depressions, screw holes, flexible bands, O-rings, or other suitable means to secure the switch plate to the gasket module, thereby restricting the switch plate's horizontal movement when resting on top of the gasket module. In embodiments, The top portion of the gasket module 300 can wrap around or “sandwich” an edge of the switch plate to restrict the switch plate's horizontal movement.

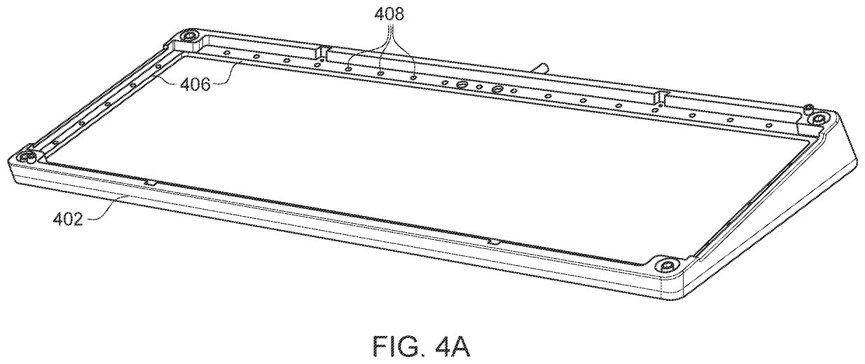

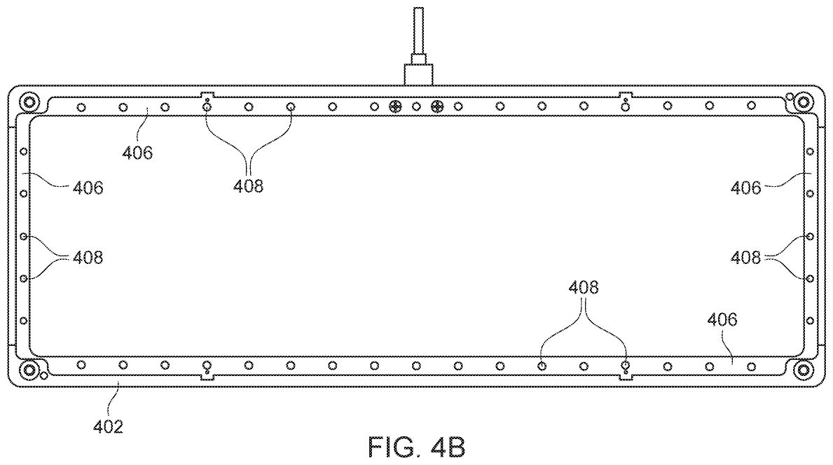

FIGS. 4A-4B depict embodiments of a portion of a keyboard case 402 to which one or more gasket modules (e.g., gasket module 300) can be connected. Keyboard case 402 can include one or more rails 406 positioned along one or more sides of a perimeter of the keyboard case 402 and/or other interior locations within the keyboard case 402. The one or more rails 406 can be an integrated portions of the keyboard case 402 or they can be separate components that are affixed to the keyboard case 402. The rails 406 can be of any size or shape and can be made of the same or a different material (e.g., plastic or metal) as the keyboard case 402. A top surface of the one or more rails 406 can include one or more connection points 408 for connecting the keyboard case 402 to one or more gasket modules. The one or more connection points 408 can be or comprise one or more of male connectors, female connectors, magnetic connectors, hook and loop connectors, or any other connector that can be used to removably connect one or more gasket modules (e.g., gasket module 300) to a corresponding surface on the keyboard case 402. The connection points 408 can be disposed uniformly and equidistant from one another on each of the one or more rails 406. In embodiments, keyboard case 402 can comprise a rail 406 on each of its four sides, with each rail comprising a plurality of connection points 408, as illustrated in FIGS. 4A-4B. A rail 406 can comprise more connection points 408 than can be usable by corresponding gasket modules at any one time to allow for more customization options. Accordingly, some or all of the connection points 408 can be used when connecting one or more gasket modules in accordance with embodiments of the invention.

In embodiments, the one or more connection points 408 are complementary to the one or more gasket connectors 310. For example, if one or more of the gasket connectors 310 are male connectors or protrusions extending downward from a bottom surface of the gasket module as illustrated in FIGS. 3A-3B, one or more of the connection points 408 can be or comprise female connectors or openings in or on the rails 406 as illustrated in FIGS. 4A-4B. Likewise, if one or more of the gasket connectors 310 are made of a magnetic material, one or more of the connection points 408 can be made of or comprise a complementary magnetic material. Other combinations of complementary gasket connectors 310 and connection points 408 can be utilized without departing from the scope of the invention, including bolts/screws and corresponding threaded holes, clamps or flexible bands and corresponding tabs, and bumps or ridges and corresponding slots or depressions. In some embodiments, the entire surface of a rail 406 can be a connection point 408. For example, if a gasket connector 310 is a magnet, and the surface of the rail 406 is a made of or comprises a magnet or a ferrous metal, the gasket connector 310 can be connected at any point on the rail 406.

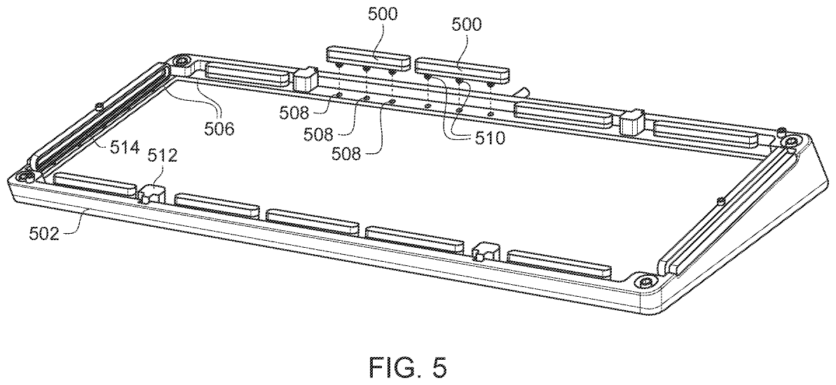

FIG. 5 depicts embodiments of a keyboard case 502, comprising one or more rails 506. The one or more rails 506 can comprise one or more connection points 508. One or more gasket modules 500 comprising one or more gasket connectors 510 can be connected to the keyboard case 502. In embodiments, the gasket connectors 510 can connect directly into corresponding connection points 508 as illustrated in FIG. 5.

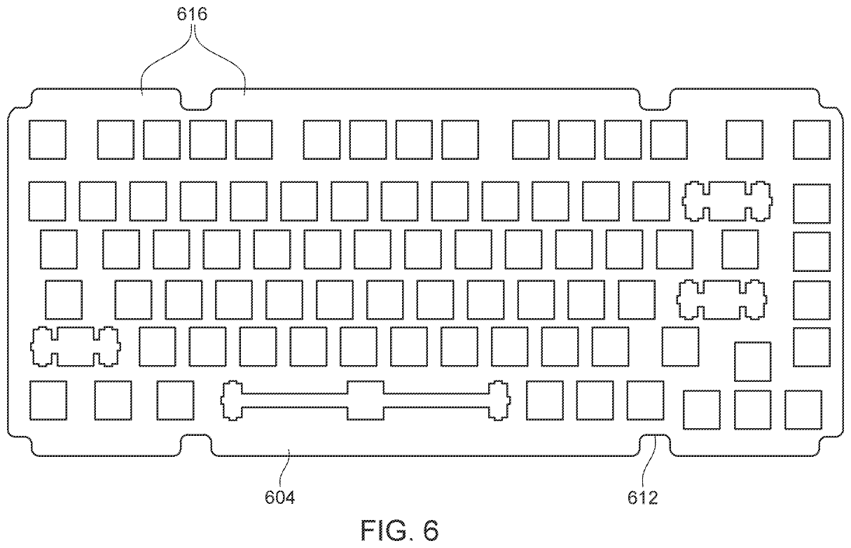

In embodiments, each gasket module 500 can be easily inserted and removed, without tools or adhesives, from any corresponding connection point 508 on any rail 506, providing a variety of customization options for a user of the invention. A user may, for example, choose to fill all available locations for maximum support of the switch plate (e.g., switch plate 604 in FIG. 6) or only some of the available locations for less support. By customizing the amount of support, a user can make fine adjustments to a switch plate's vertical travel and/or flex and the overall feel of the keyboard. Each gasket module can be added, removed, and reused indefinitely, thereby reducing waste as a user customizes their keyboard.

In the exemplary embodiment illustrated in FIG. 5, each gasket module 500 comprises three gasket connectors 510 and is configured to occupy three connection points 510. In embodiments, gasket modules 500 can be different sizes (e.g., longer, wider, taller, etc.), comprise different numbers of gasket connectors 510, and can be mixed in different combinations (i.e., not all gasket modules 500 need to be identical). Users can use different numbers of gasket modules 500, occupying more or less space, and providing customized levels of support to the switch plate.

Gasket modules 500 can also be made from different materials or different variations of the same materials to provide unlimited customization options. In embodiments, some gasket modules 500 can be more compressible (e.g., using a more flexible or deformable foam or rubber compound) while others are less compressible (e.g., using a more rigid foam or rubber compound). Users can choose gasket modules or combinations of gasket modules that provide a desirable feel.

Gasket modules 500 can also be different shapes. For example, gasket modules can be linear (e.g., as illustrated in FIG. 5), L-shaped (e.g., for corner installations), C-shaped (e.g., for installation on two sides), or rectangular (e.g., for installation on four sides. In the exemplary embodiment illustrated in FIG. 5, the keyboard case 502 is rectangular and the rails 506 are positioned only along the perimeter of the keyboard case 502. In alternative embodiments, keyboard case 502 can be a different shape (e.g., trapezoidal), divided into two or more portions (e.g., as in a split or ergonomic keyboard), and/or comprise one or more rails 506 on the interior of the keyboard case 502.

In addition to or as an alternative to gasket modules 500, one or more other keyboard components can be configured to removably connect to the rails 506 on keyboard case 502. For example, one or more switch plate locators 512, each comprising its own connector, can be connected to one or more connection points 508 on a rail 506. One or more switch plate locators can be configured to limit a switch plate's horizontal movement when installed. For example, switch plate 604 in FIG. 6 can comprise one or more anchor locations 612 that are configured to fit around one or more switch plate locators 512. In embodiments, a user can, for example, relocate one or more switch plate locators 512 to accommodate different switch plate designs and configurations. In the same or alternative embodiments, switch plate locators can be integrated directly onto gasket modules 500. For example, a gasket module 500 can have a switch plate locator on its top surface, and an anchor location 612 can be configured to fit around the switch plate locator.

In embodiments, one or more light diffusers 514 can be connected to one or more available connection points 508 on a rail 506. Light diffusers 514 diffuse light that is generated by one or more lights inside the keyboard case 502 and emanates outside of the keyboard case 502. In embodiments, a user can, for example, use different light diffusers 514 for different lighting effects. In the same or alternative embodiments, one or more additional keyboard components can be connected to one or more available connection points 508 on a rail 506. Additional keyboard components can include, for example, lights, vents, switches, knobs, dials, touch controllers, and/or other keyboard components.

FIG. 6 depicts embodiments of an exemplary switch plate 604. As discussed above, switch plate 604 can have one or more anchor locations 612 that are configured to fit around one or more switch plate locators 512. The shape and location of the anchor locations 612 can vary according to the design and configuration of the switch plate 604. For example, the anchor locations 612 can be holes, indentations, or cutouts in the switch plate 604 and/or around the perimeter of the switch plate 604. Switch plate 604 has one or more surfaces 616 that are configured to rest on (and/or be secured to) one or more gasket modules (e.g., gasket modules 500). When the switch plate 604 is installed in a keyboard case, the underside of the surfaces 616 can rest on top of one or more gasket modules, and the anchor locations 612 can fit around one or more switch plate locators 512. This configuration limits the horizontal movement of switch plate 604 while simultaneously permitting an amount of vertical travel and/or flex that is dependent upon a user's selection and inclusion of one or more gasket modules.

In some embodiments, a switch plate can have one or more tabs or prongs around the perimeter of the switch plate that are configured to both rest on one or more gasket modules and fit around one or more switch plate locators. In some embodiments, a keyboard can simultaneously have two or more independent switch plates (e.g., in a split keyboard), each of which can be mounted to the keyboard case in accordance with the present invention.

In embodiments, the switch plate 604 and all other components of the keyboard attached to the switch plate 604 (e.g., one or more printed circuit boards, key switches, and keycaps) can be supported by the one or more gasket modules 500. When the keyboard is not in use, the one or more gasket modules 500 can support the weight of the switch plate 604 and all the components attached to the switch plate 604 without deforming from the original shape of the one or more gasket modules 500. When the keyboard is in use, the one or more gasket modules 500 can compress or deform, allowing the switch plate 604 and attached components to move vertically in response to a keypress. A single key press can cause one or more gasket modules 500 to compress or deform in response to the key press, but not necessarily all of them. For example, if a user presses down the “Q” key, one or more gasket modules 500 located in an upper left-hand corner of the keyboard can compress or deform, but one or more gasket modules 500 located in a lower right-hand corner of the keyboard may not deform or buckle in response. Once the “Q” key has been released, the affected one or more gasket modules 500 can return to their original form.

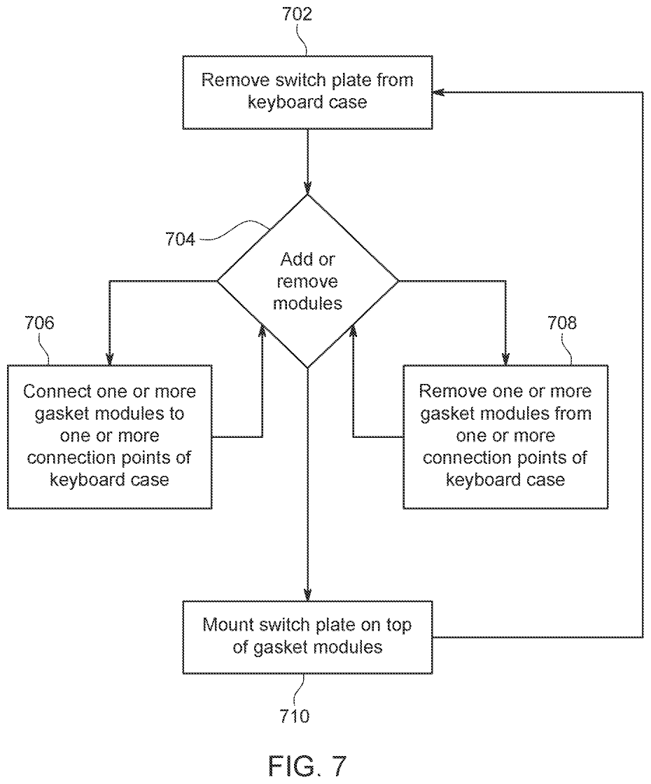

FIG. 7 depicts a flow chart of an exemplary method in accordance with the present invention. At step 702, a user of the present invention can remove the switch plate from a keyboard case to, for example, change the number, type, arrangement, orientation, or position of one or more gasket modules in the keyboard. At decision point 704, the user can choose to add or remove one or more gasket modules from the keyboard. At step 706, the user can connect one or more gasket modules to one or more connection points on the keyboard case and then return to decision point 704. Alternatively, at step 708, the user can remove one or more gasket modules from one or more connection points on the keyboard case and then return to decision point 704. If no more gasket modules are to be added or removed, the user can mount the switch plate on top of the gasket modules at step 710. Should the user wish to repeat the process, they can return to step 702 and remove the switch plate from the case.

Although the present disclosure and its advantages have been described in detail, it should be understood that various changes, substitutions, and alterations can be made without departing from the spirit and scope of the disclosure. Moreover, the scope of the present application is not intended to be limited to the particular embodiments described in the specification. As one of ordinary skill in the art will readily appreciate substitutions presently existing or later developed that perform substantially the same function or achieve substantially the same result as the corresponding embodiments described herein may be utilized according to the present disclosure.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing summary description and the detailed description are exemplary and explanatory only and are not restrictive of the features, as claimed.

As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of +10%in a stated value.

The term “exemplary” is used in the sense of “example” rather than “ideal.” As used herein, the singular forms “a,” “an,” and “the” include plural reference unless the context dictates otherwise.

Exemplary embodiments of the systems and methods disclosed herein are described in the numbered paragraphs below.

A1. A modular mounting system for a keyboard comprising:

a keyboard case, wherein the keyboard case comprises a plurality of connection points disposed on a perimeter of the keyboard case;

a plurality of gasket modules, wherein each of the plurality of gasket modules comprises at least a top portion and a bottom portion and is configured to removably connect to one or more of the connection points; and

a switch plate, wherein the switch plate is configured to rest on the plurality of gasket modules.

A2. The modular mounting system of A1, wherein each of the plurality of connection points comprises at least one opening, and wherein the bottom portion of each of the plurality of gasket modules comprises at least one protrusion.

A3. The modular mounting system of A1, wherein each of the plurality of connection points comprises at least one protrusion, and wherein the bottom portion of each of the plurality of gasket modules comprises at least one opening.

A4. The modular mounting system of A1, wherein the top portion of each of the plurality of gasket modules is constructed from foam and the bottom portion is constructed from one of rubber or plastic.

A5. The modular mounting system of A1, further comprising a plurality of switch plate locators, wherein each of the plurality of switch plate locators is configured to removably connect to one or more of the connection points.

A6. The modular mounting system of A5, wherein the switch plate comprises a plurality of anchor locations, and each of the plurality of anchor locations is configured to fit around one of the plurality of switch plate locators.

A7. The modular mounting system of A1, wherein the number of connection points is greater than the number of gasket modules that can be used at any one time.

A8. The modular mounting system of A1, wherein each of the plurality of gasket modules can be connected, disconnected, and reused a plurality of times.

A9. The modular mounting system of A1, wherein an amount of vertical travel of the switch plate increases when one or more of the plurality of gasket modules are removed from the modular mounting system, and wherein the amount of vertical travel of the switch plate decreases when one or more of the plurality of gasket modules are added to the modular mounting system.

A10. The modular mounting system of A1, wherein the plurality of connection points comprise a magnetic or ferrous material, and wherein the bottom portion of each of the plurality of gasket modules comprises a magnetic or ferrous material.

B1. A method for mounting a switch plate in a keyboard, comprising:

connecting a plurality of gasket modules to a keyboard case, wherein the keyboard case comprises a plurality of connection points, and wherein each of the plurality of gasket modules comprises at least a top portion and a bottom portion and is configured to removably connect to one or more of the plurality of connection points; and

mounting the switch plate to the keyboard case, wherein the switch plate rests on the top portion of each of the plurality of gasket modules.

B2. The method of B1, wherein each of the plurality of connection points comprises at least one opening, and wherein the bottom portion of each of the plurality of gasket modules comprises at least one protrusion.

B3. The method of B1, wherein each of the plurality of connection points comprises at least one protrusion, and wherein the bottom portion of each of the plurality of gasket modules comprises at least one opening.

B4. The method of B1, wherein the top portion of each of the plurality of gasket modules is constructed from foam and the bottom portion is constructed from one of rubber or plastic.

B5. The method of B1, further comprising connecting a plurality of switch plate locators to the computer case, wherein each of the plurality of switch plate locators is configured to removably connect to one or more of the connection points.

B6. The method of B5, wherein the switch plate comprises a plurality of anchor locations, and each of the plurality of anchor locations is configured to fit around one of the plurality of switch plate locators.

B7. The method of B1, wherein the number of connection points is greater than the number of gasket modules that can be used at any one time.

B8. The method of B1, wherein each of the plurality of gasket modules can be connected, disconnected, and reused a plurality of times.

B9. The method of B1, wherein an amount of vertical travel of the switch plate increases by removing one or more of the plurality of gasket modules, and wherein the amount of vertical travel of the switch plate decreases by adding one or more of the plurality of gasket modules.

B10. The method of B1, wherein the plurality of connection points comprise a magnetic or ferrous material, and wherein the bottom portion of each of the plurality of gasket modules comprises a magnetic or ferrous material.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A modular mounting system for a keyboard comprising:
a keyboard case, wherein the keyboard case comprises a plurality of connection points disposed on a perimeter of the keyboard case;
a plurality of gasket modules, wherein each of the plurality of gasket modules comprises at least a top portion and a bottom portion and is configured to removably connect to one or more of the connection points; and
a switch plate, wherein the switch plate is configured to rest on the plurality of gasket modules.

2. The modular mounting system of claim 1, wherein each of the plurality of connection points comprises at least one opening, and wherein the bottom portion of each of the plurality of gasket modules comprises at least one protrusion.

3. The modular mounting system of claim 1, wherein each of the plurality of connection points comprises at least one protrusion, and wherein the bottom portion of each of the plurality of gasket modules comprises at least one opening.

4. The modular mounting system of claim 1, wherein the top portion of each of the plurality of gasket modules is constructed from foam and the bottom portion is constructed from one of rubber or plastic.

5. The modular mounting system of claim 1, further comprising a plurality of switch plate locators, wherein each of the plurality of switch plate locators is configured to removably connect to one or more of the connection points.

6. The modular mounting system of claim 5, wherein the switch plate comprises a plurality of anchor locations, and each of the plurality of anchor locations is configured to fit around one of the plurality of switch plate locators.

7. The modular mounting system of claim 1, wherein the number of connection points is greater than the number of gasket modules that can be used at any one time.

8. The modular mounting system of claim 1, wherein each of the plurality of gasket modules can be connected, disconnected, and reused a plurality of times.

9. The modular mounting system of claim 1, wherein an amount of vertical travel of the switch plate increases when one or more of the plurality of gasket modules are removed from the modular mounting system, and wherein the amount of vertical travel of the switch plate decreases when one or more of the plurality of gasket modules are added to the modular mounting system.

10. The modular mounting system of claim 1, wherein the plurality of connection points comprise a magnetic or ferrous material, and wherein the bottom portion of each of the plurality of gasket modules comprises a magnetic or ferrous material.

11. A method for mounting a switch plate in a keyboard, comprising:
connecting a plurality of gasket modules to a keyboard case, wherein the keyboard case comprises a plurality of connection points, and wherein each of the plurality of gasket modules comprises at least a top portion and a bottom portion and is configured to removably connect to one or more of the plurality of connection points; and
mounting the switch plate to the keyboard case, wherein the switch plate rests on the top portion of each of the plurality of gasket modules.

12. The method of claim 11, wherein each of the plurality of connection points comprises at least one opening, and wherein the bottom portion of each of the plurality of gasket modules comprises at least one protrusion.

13. The method of claim 11, wherein each of the plurality of connection points comprises at least one protrusion, and wherein the bottom portion of each of the plurality of gasket modules comprises at least one opening.

14. The method of claim 11, wherein the top portion of each of the plurality of gasket modules is constructed from foam and the bottom portion is constructed from one of rubber or plastic.

15. The method of claim 11, further comprising connecting a plurality of switch plate locators to the computer case, wherein each of the plurality of switch plate locators is configured to removably connect to one or more of the connection points.

16. The method of claim 15, wherein the switch plate comprises a plurality of anchor locations, and each of the plurality of anchor locations is configured to fit around one of the plurality of switch plate locators.

17. The method of claim 11, wherein the number of connection points is greater than the number of gasket modules that can be used at any one time.

18. The method of claim 11, wherein each of the plurality of gasket modules can be connected, disconnected, and reused a plurality of times.

19. The method of claim 11, wherein an amount of vertical travel of the switch plate increases by removing one or more of the plurality of gasket modules, and wherein the amount of vertical travel of the switch plate decreases by adding one or more of the plurality of gasket modules.

20. The method of claim 11, wherein the plurality of connection points comprise a magnetic or ferrous material, and wherein the bottom portion of each of the plurality of gasket modules comprises a magnetic or ferrous material.
